(19) United States
(12) Patent Application Publication
(10) Pub. No.: US 2010/0111661 A1
(43) Pub. Date: May 6, 2010

(54) VEHICLE LIFT

(76) Inventor: John J. Svanda, Oconomowoc, WI (US)

Correspondence Address: SYLKE LAW OFFICES, LLC, 756 N. MILWAUKEE STREET, SUITE 210, MILWAUKEE, WI, 53202, US

(21) Appl. No.: 12/441,068

(22) PCT Filed: Sep. 13, 2007
(86) PCT No.: PCT/US07/19850

§ 371 Date: Mar. 12, 2009

(30) Foreign Application Priority Data
Sep. 14, 2006 (US) 60844522

(51) Int. Cl. B60P 1/54; B66C 23/36; B66C 23/44; B66C 23/04

(52) U.S. Cl. 414/543

(57) ABSTRACT

A lift for loading and unloading a personal mobility vehicle into and out of a motor vehicle includes a base assembly configured for mounting the base assembly to a motor vehicle storage space support surface. A mast assembly is coupled to the base assembly and has a generally vertical post coupled to the base assembly. An offset arm is secured to the upper end of the post. A head assembly having a generally horizontal boom is coupled to the mast assembly and encloses a belt for raising and lowering cargo. Embodiments of the invention can include a multi-configuration positioning apparatus can use a reversible head mount coupled to the vertical post and/or a multi-positional base unit as part of the base assembly. A direct drive apparatus using a mast motor can be used to rotate the mast in some embodiments. A belt compensation apparatus uses a controller to coordinate operation of a belt motor and a boom extension motor to maintain a suitable belt length and vertically belt clearance during extension and retraction of the boom by the boom extension motor.

### PRIORITY CLAIM AND CROSS-REFERENCE TO RELATED APPLICATIONS

This application claims the benefit of priority under 35 U.S.C. §119(e) and any other United States or other law of the following: U.S. Ser. No. 60/844,522 (Atty. Docket No. 0201-p19p) filed Sep. 14, 2006, entitled VEHICLE LIFT, the entire disclosure of which is incorporated herein by reference in its entirety for all purposes.

### TECHNICAL FIELD

This invention relates generally to methods, systems and apparatus for implementing lifts, hoists and the like in motor vehicles, especially for use in connection with personal-mobility devices such as scooters, wheelchairs, etc.

### BACKGROUND

With the growing aging population, there are increasing numbers of mobility-impaired persons relying on mobility devices such as powered wheelchairs (PWCs) and power operated vehicles (POVs), or scooters, for an independent lifestyle. In order for those disabled persons to drive or ride as passengers in private motor vehicles, several means of transporting their mobility devices have been devised, such as trunk lifts, platform lifts and ramps. Crane-type hoists have been known and used for several years to accommodate loading and transporting mobility devices in hatchback-type vehicles such as minivans and SUVs.

### BRIEF DESCRIPTION OF DRAWINGS

The present invention will be readily understood by the following detailed description in conjunction with the accompanying drawings, wherein like reference numerals designate like structural elements, and in which:

FIG. 1 is an isometric view of a lift according to one or more embodiments of the present invention.

FIG. 2 is an exploded view of a lift according to one or more embodiments of the present invention.

FIG. 3 is another exploded view of a lift according to one or more embodiments of the present invention wherein a driver side configuration and a passenger side configuration are illustrated.

FIGS. 4 and 5 are side views of a lift according to one or more embodiments of the present invention.

FIG. 6 illustrates a reversible base usable in connection with one or more embodiments of the present invention.

FIG. 7 illustrates a reversible base usable in connection with one or more embodiments of the present invention.

FIG. 8 is an exploded view of a reversible base usable in connection with one or more embodiments of the present invention.

FIGS. 9, 10 and 11 are top plan views of a lift according to one or more embodiments of the present invention mounted in various orientations relating to a vehicle cargo area and support surface, wherein driver side configurations and passenger side configurations are illustrated.

FIG. 12 illustrates top plan and side views of a drive unit according to one or more embodiments of the present invention.

FIG. 13 illustrates various detailed views of a drive unit according to one or more embodiments of the present invention.

FIG. 14 illustrates an exploded view of a drive unit according to one or more embodiments of the present invention.

FIG. 15 illustrates left hand and right hand mounting of a head assembly mount on a mast according to one or more embodiments of the present invention.

FIGS. 16-21 illustrate a head assembly, including boom extension and belt compensation systems, according to one or more embodiments of the present invention.

### DETAILED DESCRIPTION

The following detailed description of the invention will refer to one or more embodiments of the invention, but is not limited to such embodiments. Rather, the detailed description is intended only to be illustrative. Those skilled in the art will readily appreciate that the detailed description given herein with respect to the Figures is provided for explanatory purposes as the invention extends beyond these limited embodiments.

As mobility devices have increased in size and weight, it has become essential to provide hoists that require less space in vehicle cargo compartments which, if anything, are becoming smaller as vehicles are downsizing. Additionally, as the variety of hatchback vehicle models has proliferated, so has the variety of mobility devices. In many motor vehicles, the bumper designs also have grown. In order to provide a more universal hoist to accommodate the increasing variety of vehicle and mobility device combinations, certain improvements in design have been made.

One of the most popular types of hoist for hatchback-type vehicles comprises a mounting base used to fasten the hoist to the vehicle floor. A mast assembly coupled to the mounting base provides a vertically elevated position for a lifting means, for example a boom to extend outside the vehicle and rotate the cargo (for example, mobility device) into the vehicle, a hoist drive system (for example, lift head assembly) for lifting the cargo, and an additional mast drive system to rotate the mast assembly (and any cargo carried by the lifting means) into the vehicle. For some vehicles, a third axis of horizontal linear motion is desired and/or required to extend the mast and mobility device beyond the vehicle (for example, beyond a vehicle bumper or the like). Embodiments of the present invention described and claimed herein are improvements over previous crane-type hoists.

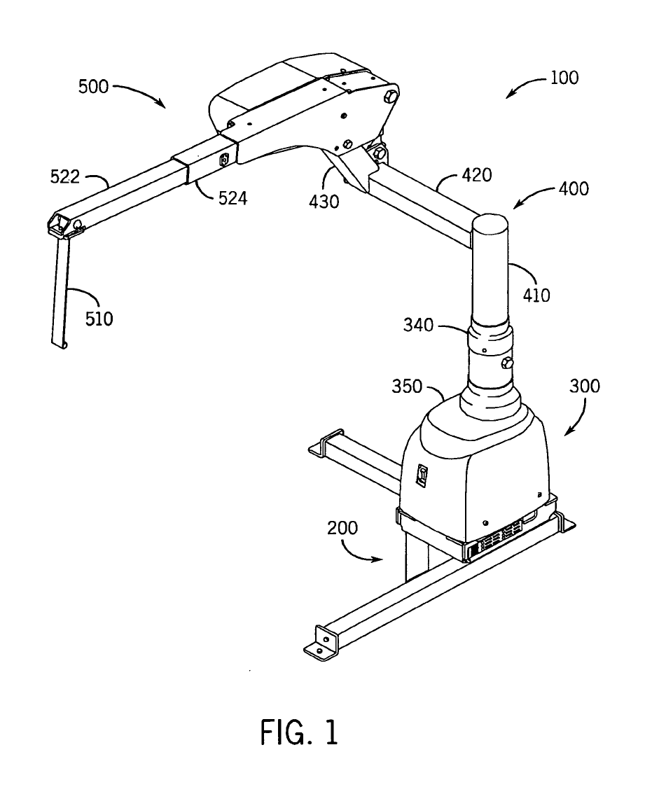

As seen in the example of FIG. 1, the present invention includes embodiments of a lift 100 having a reversible base 200 to which a drive unit 300 is mounted. The drive unit can include a direct drive according to some embodiments of the present invention, a drive that does not use any flexible linkages between the motor or similar device and the mast assembly component being rotated. A mast 400 that can incorporate a reversible head mount is coupled to the drive unit and a lift head assembly 500 is then coupled to the mast. A boom extension compensation system can be employed in some embodiments of the present invention to compensate a lift belt position for horizontal extension and/or retraction of the boom.

The phrases “coupled to” and “connected to” and the like are used herein to describe a connection between two elements and/or components and are intended to mean coupled either directly together, or indirectly, for example via one or more intervening elements, where appropriate.

A mounting base according to one or more embodiments of the present invention is less confusing to assemble and install as compared to bases of earlier systems. It typically is desirable to mount the hoist as close to the rear hatch and adjoining interior wall (driver or passenger side) of the cargo area as practical. To accomplish this, a configurable base geometry is necessary. The mounting base provides a means of securing the hoist drive system and mast assembly to the vehicle floor using two leg extensions, generally at a right angle, to spread the loads resulting from lifting and rotating the mobility device. Instead of providing incremental adjustment of the base mounting legs via spaced holes, continuous adjustment is provided using telescoping tubes secured with set screws. This simplifies floor hole alignment during installation. The base provides, optionally, 3 or 4 fastening locations to secure the base to the vehicle floor. An additional offset leg position is provided for the forward-facing leg to clear the fender well on some applications. Also, the base assembly is symmetrical and can be turned upside down for mounting either on the passenger side (for example, the right side in the United States) or the driver side (for example, the left side in the United States) at the rear of the cargo area, adjacent to the hatch door. Additionally, flipping the base in this manner can provide a rear offset configuration.

Lifts according to embodiments of the present invention are modular in the sense that a multi-configurational positioning apparatus can include a base assembly described in detail below and/or a reversible head mount described in detail below to permit a wide variety of mounting configurations, positions and/or orientations using the a single set of components comprising the multi-configurational positioning apparatus, without the need for component customization or numerous different parts for achieving different orientations (for example, driver side versus passenger side configurations, right hand versus left hand head assembly orientations, rear offset spacing in a vehicle's storage space, side offset (from a wheel well or the like, for example) in the vehicle's storage space, etc.). This modularity means that a simple set of parts can be configured in many different ways to achieve a highly flexible and adaptable lift unit that can be installed, maintained and altered by a dealer or other individual responsible for the installation and implementation of vehicle lifts.

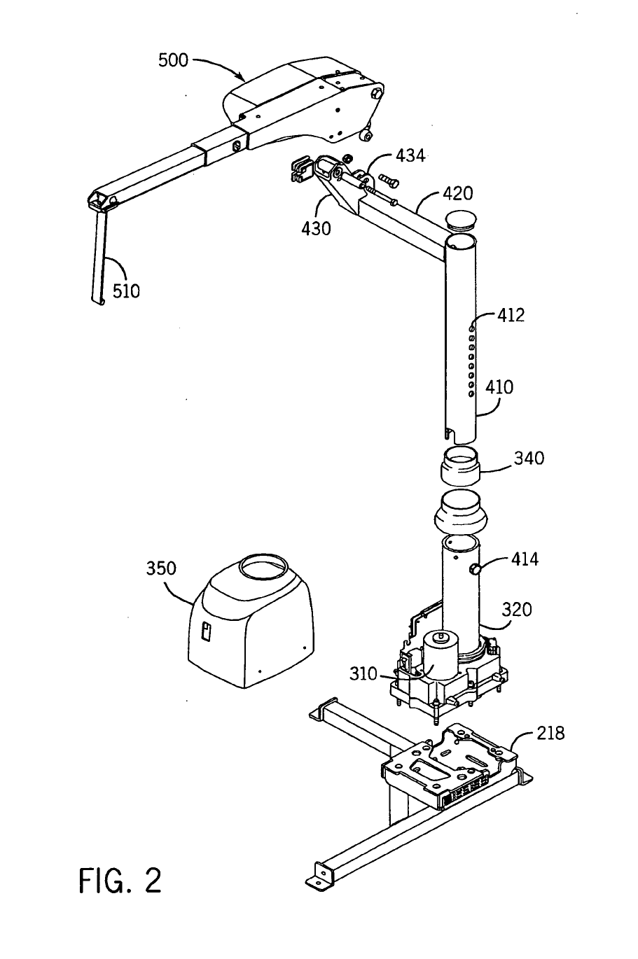

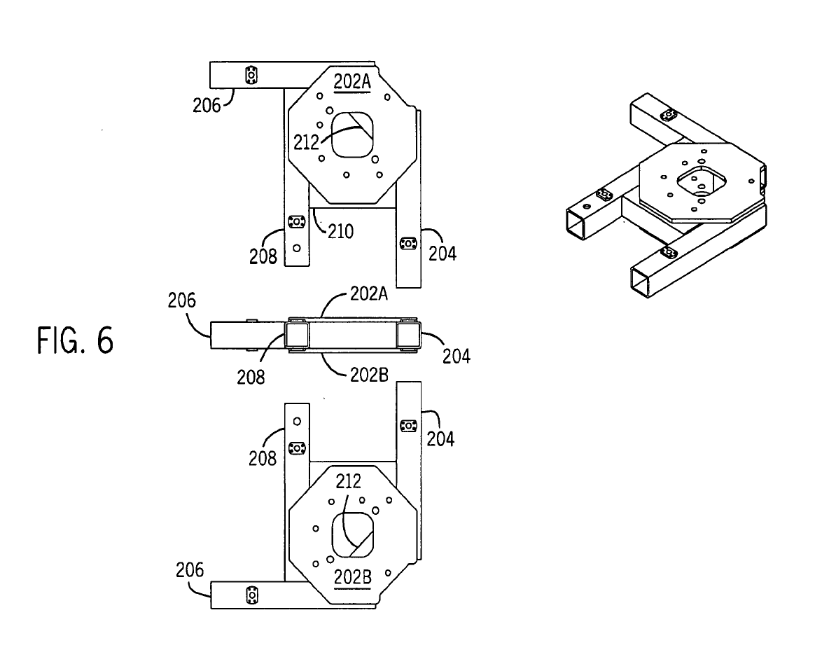

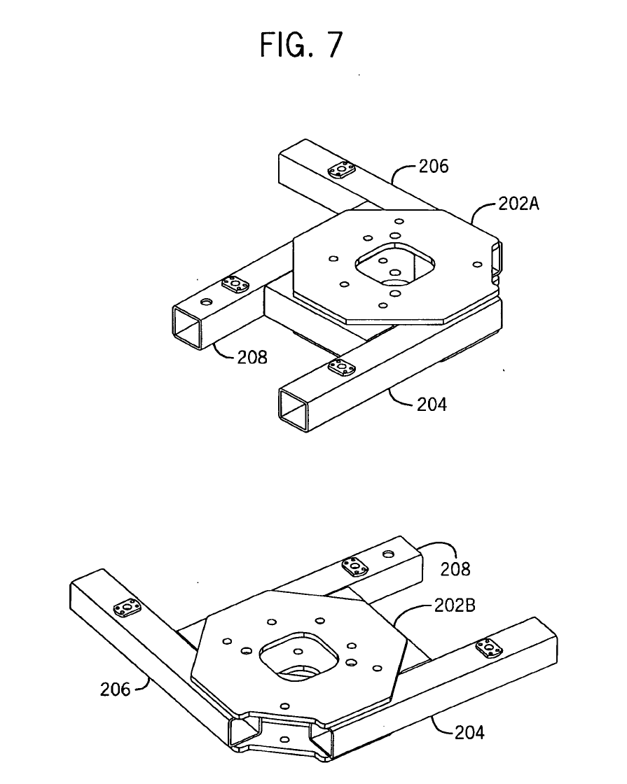

The base unit 200 (also referred to as a base assembly), shown in FIGS. 1-3, is configured to be mounted to a vehicle floor, trunk floor, etc. or any other generally structural support that usually is a horizontal support surface 105. As seen in FIGS. 6 and 7, the base unit 200 can include a pair of reversible mounting plates 202A, 202B to which are affixed a first leg 204, a second leg 206 and a third leg 208. Legs 204, 206, 208 can be welded or attached to plates 202A, 202B in any appropriate manner.

Leg 204 and leg 206 are set at an angle that permits stable mounting of the lift 200. Typically a 90° angle can be used as the mounting angle, though the present invention is not limited to this configuration. An angle brace 212 can be used to help hold legs 204, 206 in a fixed mounting angle.

Leg 208 is mounted parallel to leg 204 in the embodiment of FIGS. 6 and 7 for reasons discussed in more detail below. A support leg 210 can be used to help hold legs 204, 208 in parallel relation to one another. As seen in FIGS. 6 and 7, when plate 202A is on top of the base unit 200, parallel legs 204, 208 are angularly displaced from leg 206 by an acute angle counterclockwise from leg 206. Likewise, when plate 202B is on top of unit 200, then legs 204, 208 are displaced from leg 206 by an acute angle clockwise from leg 206. This feature, too, will be discussed in more detail below.

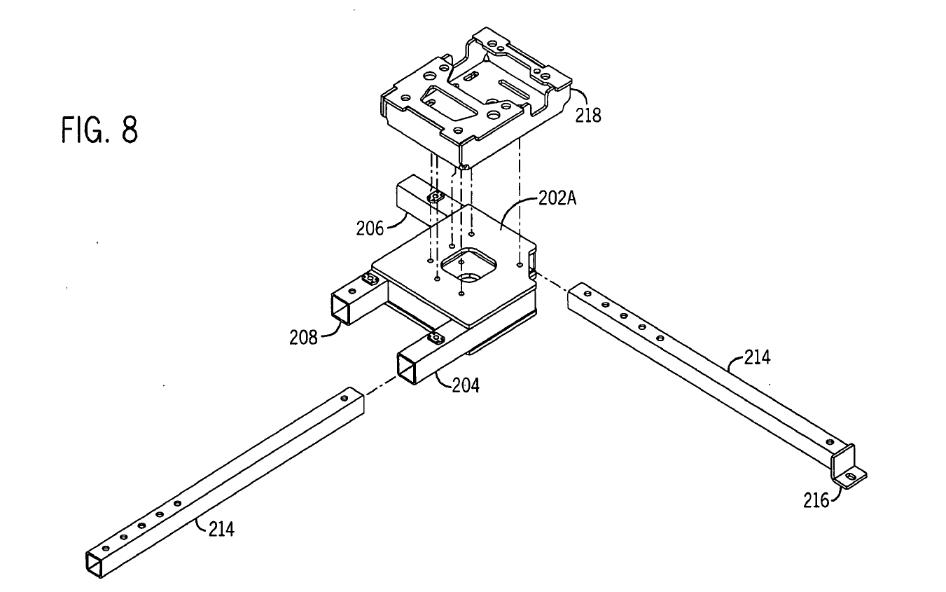

FIGS. 1-3 and 8 show one or more legs 204, 206, 208 including telescoping components 214 that allow the legs to be adjusted as to length and anchoring point (which can be anchored to a support surface using a bolt, rivet or any other equivalent anchoring means). Likewise, an extender 214 may have one or more mounting feet 216 for assisting in anchoring the base unit 200 to the support surface 105, as seen in FIGS. 1-3 and 8. Other legs and anchoring apparatus to assist in securing the base unit 200 to an appropriate support surface. As will be appreciated by those skilled in the art, the base box 218 shown secured to plate 202A can be similarly secured to plate 202B when base unit 200 is flipped over to provide other configurational options.

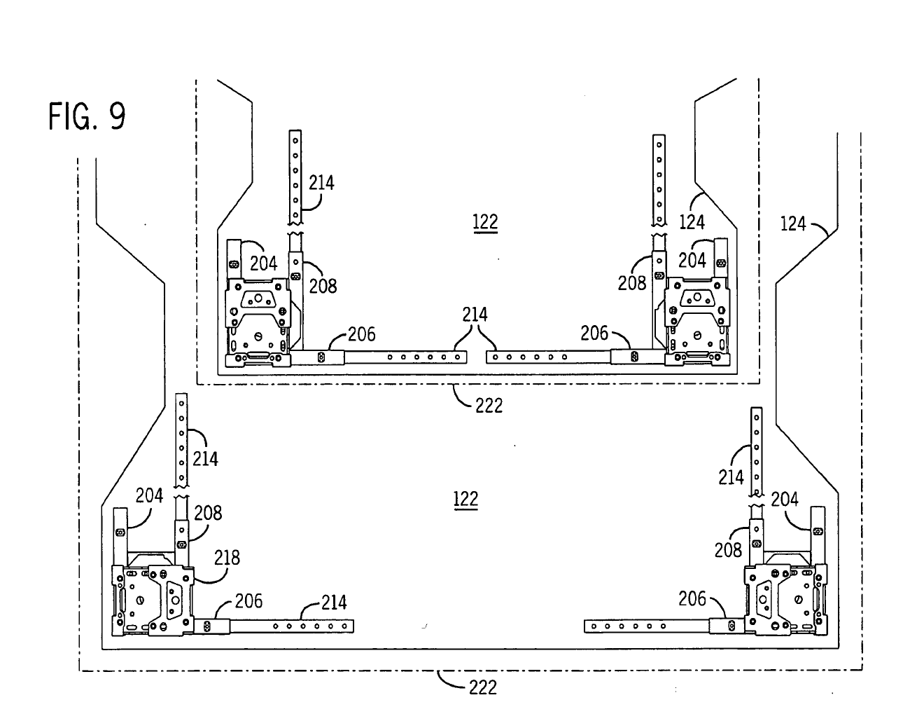

FIGS. 9, 10 and 11 show different configurations/positions for the lift 100 in the trunk of a car, the back of an SUV, floor of a minivan, etc. Each FIGS. 9, 10 and 11 has two configuration layouts that in turn each show two positions for mounting an embodiment of the present invention. As will be seen in FIGS. 9, 10 and 11, the configurations on the left side are “driver side” configurations (or DS configurations) and the configuration on the right side are “passenger side” configurations (or PS configurations). These various configurations achievable using the multi-configurational positioning apparatus described herein reflect the ability of embodiments of the present invention to accommodate different locations and obstacles (for example, a wheel well, spare tire, etc.) with regard to the support surface on which the lift is mounted.

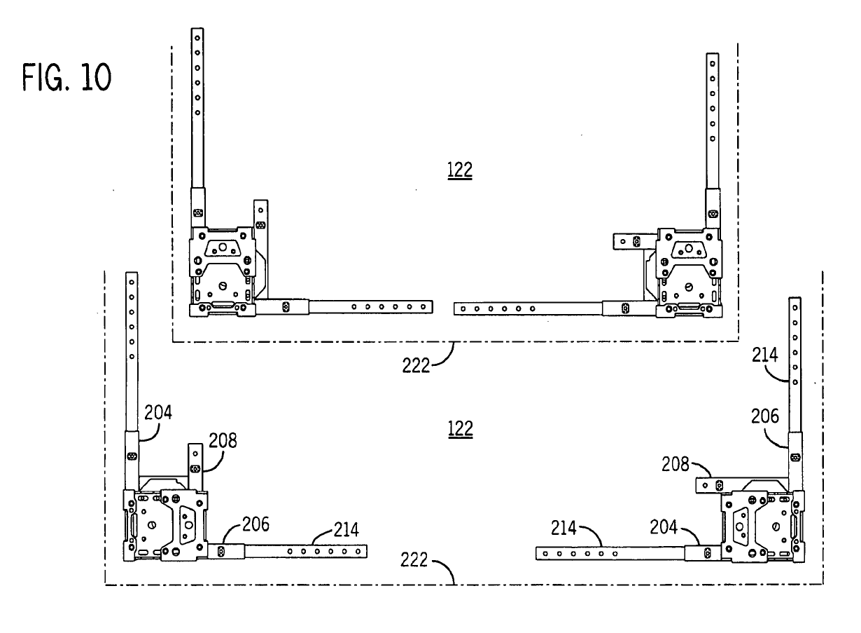

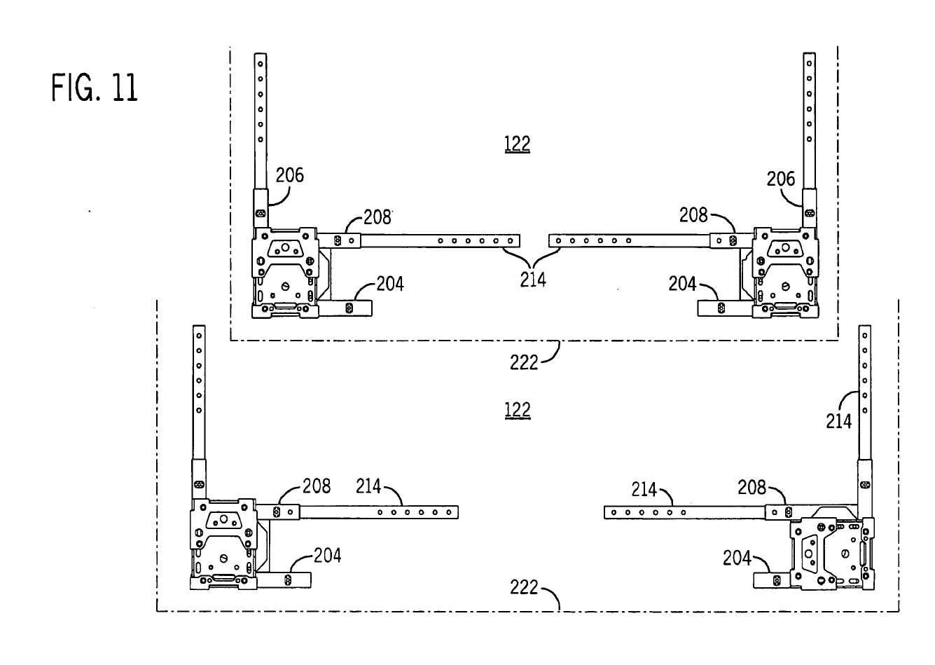

In each FIGS. 9, 10 and 11, support surface 122 ends on one side with a vehicle rear bumper 222. In the two configuration layouts shown in FIG. 10 legs 204, 206 are used for anchoring the lift 100 to support surface 122 and leg 208 is either unused or is supplemental to the other legs. In the configurations of FIG. 10, no wheel well or other obstruction is present that would otherwise require use of a different configuration regarding the side of the vehicle storage space and no rear setback or offset is required along the rear of the storage space. In the two configuration layouts shown in FIG. 11 leg 208 is used parallel to bumper 222 so that a rear offset configuration is provided. Finally, in the two configuration layouts shown in FIG. 9, wheel wells 124 adjacent the support surface 122 make use of leg 208 more desirable. Again, leg 204 is unused and leg 206 is used in its normal configuration, this time parallel to the rear bumper 222 with no rear offset. Those skilled in the art will appreciate that other configurations of the “flippable” base unit of the present invention can be implemented. As shown in FIGS. 9-11, a base box 218 is used as a spacer and mounting platform between one of the base plates 202A, 202B and the drive unit 300. Depending on the intended use and/or environment in which lift 100 is used, this base box (which can be part of the multi-configurational positioning apparatus) can be oriented in any suitable fashion.

In some embodiments of the present invention, the mast drive system is comprised of an enclosed gearbox with an external, serviceable, motor that is fastened directly to the mounting base and supports the mast assembly. Limit switches can be pre-set to provide rotation end points constraining the mast rotation while moving the mobility device out from or in to the vehicle cargo area. Because the limit switches can be adjusted to restrict rotation between any two points over 360 degrees, the mast drive system can be configured in the field to a passenger side, driver side or other location.

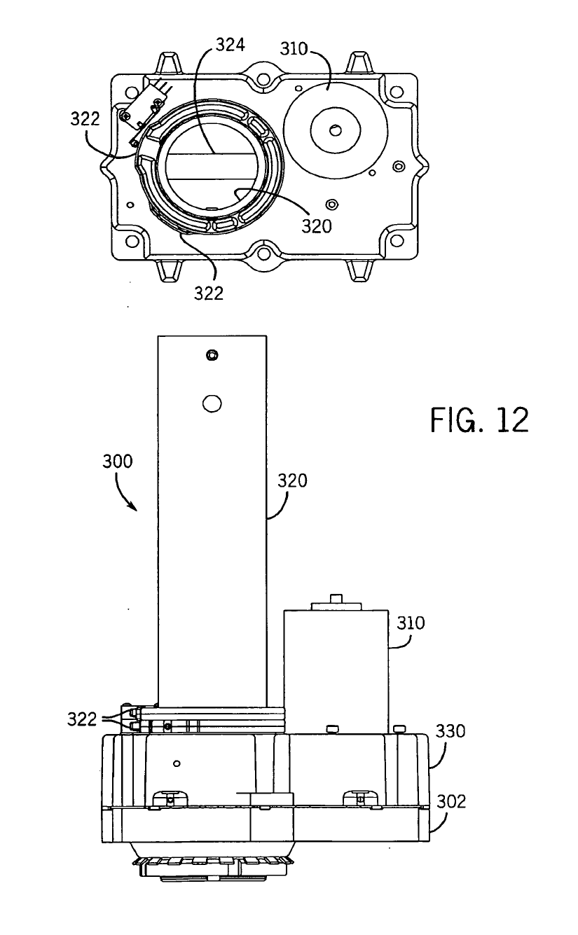

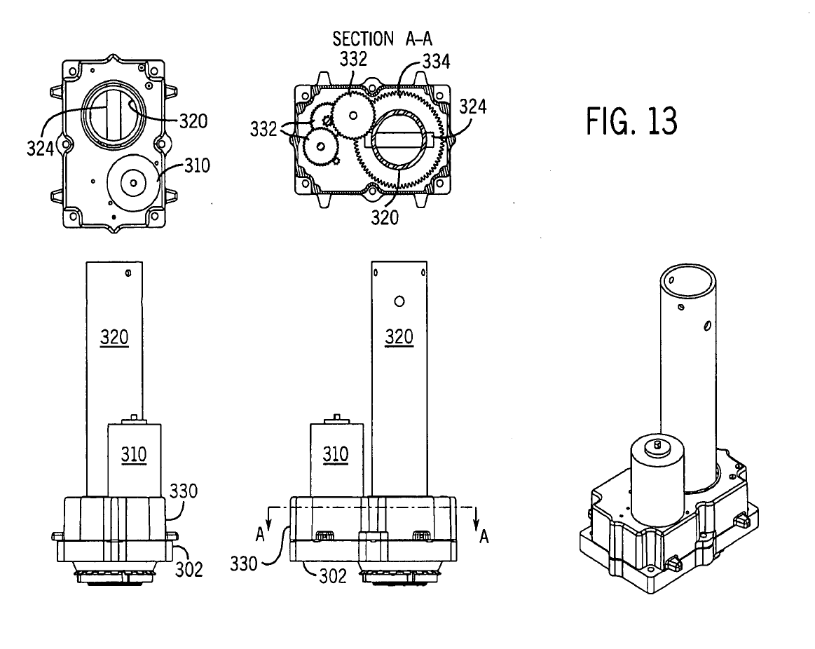

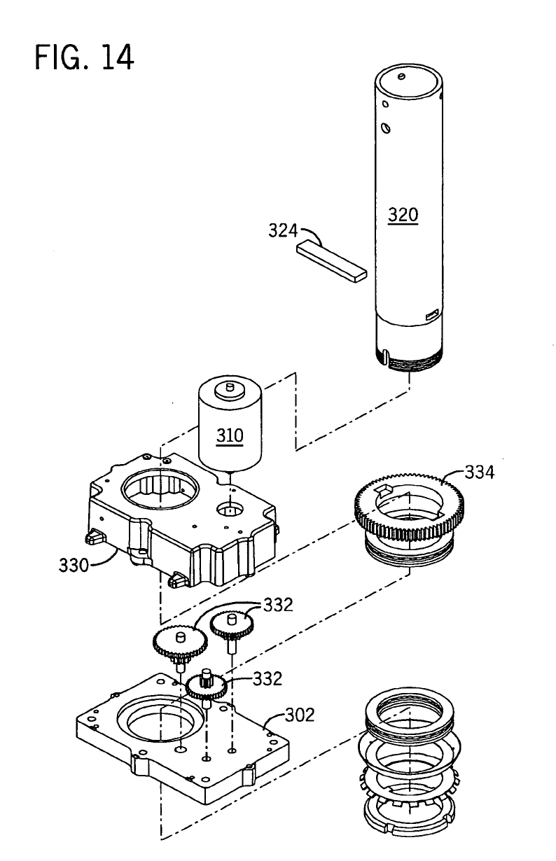

FIGS. 12-14 show one embodiment of the drive unit 300 of the present invention which, in the embodiment illustrated in the Figures, is a direct drive system (which may use a gear cluster or the like, but not using belts, chains, or other flexible linkages to transmit motion from the motor to the mast for rotation of the mast). A mounting plate 302 can be affixed to base box 218 using bolts or any other equivalent mounting means so that base box 218 provides spacing for the drive unit. A motor 310 likewise is mounted to plate 302 adjacent a generally vertical mounting tube 320 that can include limit switches 322 used to establish the rotational limits of the mast 400 during normal operation of the lift 100. A gearbox cover 330 can be used to house the gear cluster 332 that transmits the output of the shaft of motor 310 to a final drive gear 334 to which mast rotation tube 320 is secured (for example, by threaded screwing of the mast rotation tube 320 to the final drive gear 334). A cross-member 324 can be used in the interior of gear 334 and tube 320 to transmit rotational motion from the gear cluster 332 of the drive system to the tube 320. Other drive means are well known to those skilled in the art and can be used in lieu of the specific structure illustrated in the Figures for rotating the mast assembly 400.

As will be noted from the Figures, embodiments of the present invention use a direct drive system for rotating the mast assembly 400. That is, the motor 310 drives tube 320 directly; no chains or other flexible linkages are used. The sealed gearbox requires no adjustments (as a chain drive would), lubrication, or other scheduled maintenance for the life of the hoist. It also resists entry of contaminants such as water or grime. Being more compact than bulky chain drive systems, additional vehicle applications can be accommodated where cargo space is restricted.

As seen in FIGS. 1-3, a hood or other cover 350 can be used to enclose the entire drive unit including motor 310, mounting tube 320, etc. for cosmetic reasons as well as to prevent dirt and other materials from accumulating, etc. A collar 340 can be placed over the upper end of the mounting tube 320 to enclose the joint between the mounting tube 320 and the vertical post 410 of mast 400.

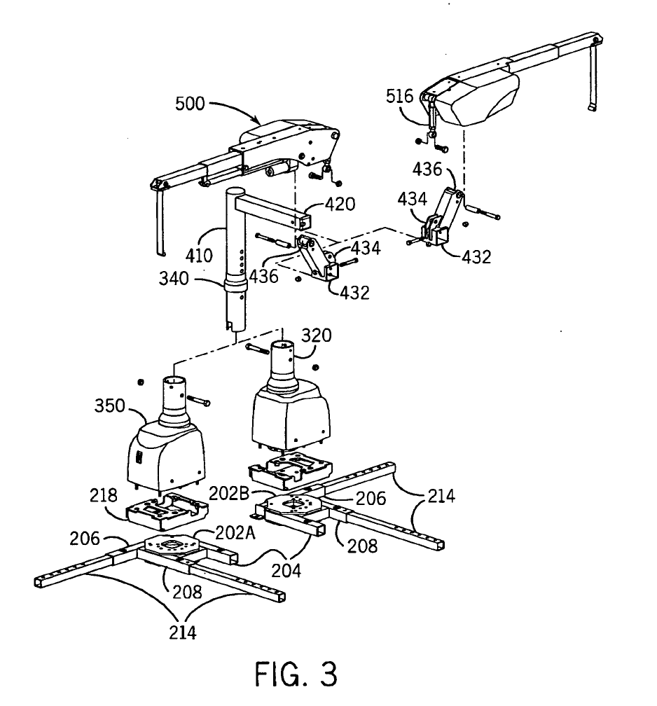

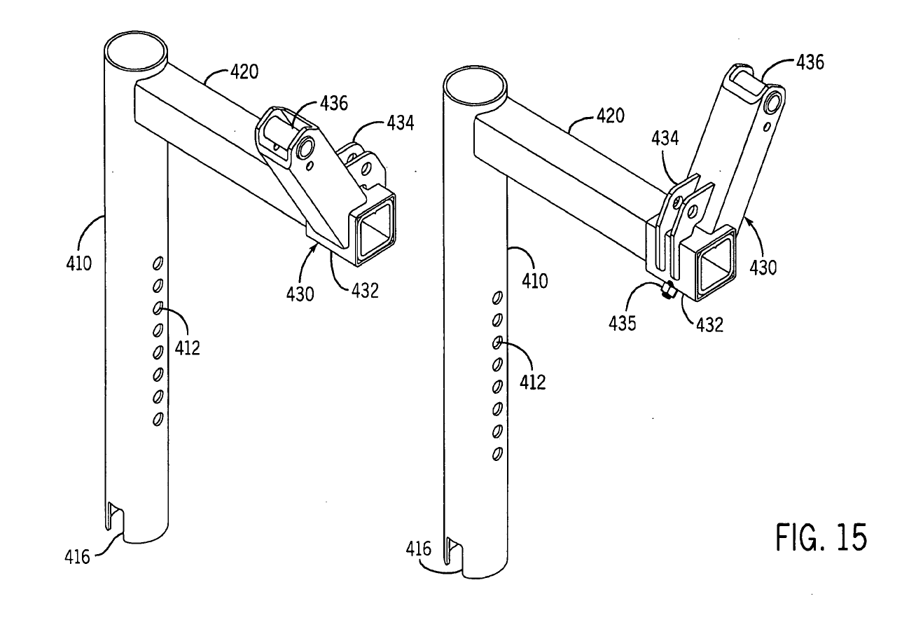

The mast assembly 400 is mounted on top of the mast drive means 300 and features an optional offset arm 420 to facilitate positioning a mobility device or other cargo alongside a vehicle for lifting (for example, on a sidewalk). FIGS. 3 and 15 show one embodiment of the mast 400, which includes a vertical segment or upright, in this case a post 410 (providing mounting and option vertical adjustment) and the optional horizontal offset arm 420. As seen in the Figures, post 410 has height adjustment holes 412 that allow post 410 to be mounted to tube 320 at a desirable height setting. A bolt 414 or other locking means can be used to hold post 410 in position relative to tube 320. In embodiments where such height adjustment is available, the bolt 414 also transmits the rotational motion of the mast rotation tube 320 to the post 410. Notches 416 in the bottom of post 410 provide clearance of the member 324 when the height of post 410 is lowered. Thus when motor 310 rotates tube 320, post 410 and mast 400 rotate in a generally equivalent manner due to the transmission of rotation motion by member 324 and bolt 414. In embodiments of the invention using a mast rotation tube 320 and post 410, the combination of these two components can be considered the vertical upright as a whole. In other embodiments where a mast rotation tube 320 or the like is not used, the direct drive of the drive unit 300 can directly engage the post itself without the intermediate rotation tube.

Optional horizontal offset arm 420 can be welded or affixed to post 410 by any other suitable means. Alternatively, arm 420 and post 410 can be components of a unitary mast 400.

As seen in the Figures, especially FIGS. 3 and 15, the outer end of arm 420 has a reversible head mounting mechanism 430, so that the hoist can be configured by the dealer/installer for passenger or driver side mounting. Mechanism 430 is part of the modular mounting system according to some embodiments of the present invention that provides a wide variety of mounting configurations and/or orientations using the same components. Mechanism 430 is used to mount head assembly 500 to the mast 400. In the embodiment of the present invention shown in FIGS. 3 and 15, mechanism 430 includes a mounting sleeve 432 that is designed to slide axially over the outermost end of offset arm 420 using either end of sleeve 432. Sleeve 432 can be secured to the offset arm 420 using a set screw 435 or any other suitable securing means. A brace 434 and offset pivot 436 are affixed to sleeve 432 in a generally perpendicular orientation relative to the axis of sleeve 432. In this way mechanism 430 can be used for both “right hand” and “left hand” mountings of the head assembly 500. If the head assembly 500 is mounted in a left hand orientation and a right hand orientation is desired, the head 500 is removed from mechanism 430, the mechanism 430 is “flipped,” and the head is then re-mounted to the right hand orientation. This embodiment of the present invention provides a very simple and easily implemented way of reversing the orientation of head assembly 500, thus enhancing the multiple configuration capabilities and capacity of a hoist according to one or more embodiments of the present invention.

The head assembly 500 (also referred to as a lift head assembly or boom assembly) is modular, can be provided with optional lifting features, and typically is pivotally mounted atop the mast assembly. A simple embodiment of the head assembly 500 includes a continuously-adjustable boom 520 with a winch-type hoist mechanism, as described in more detail below.

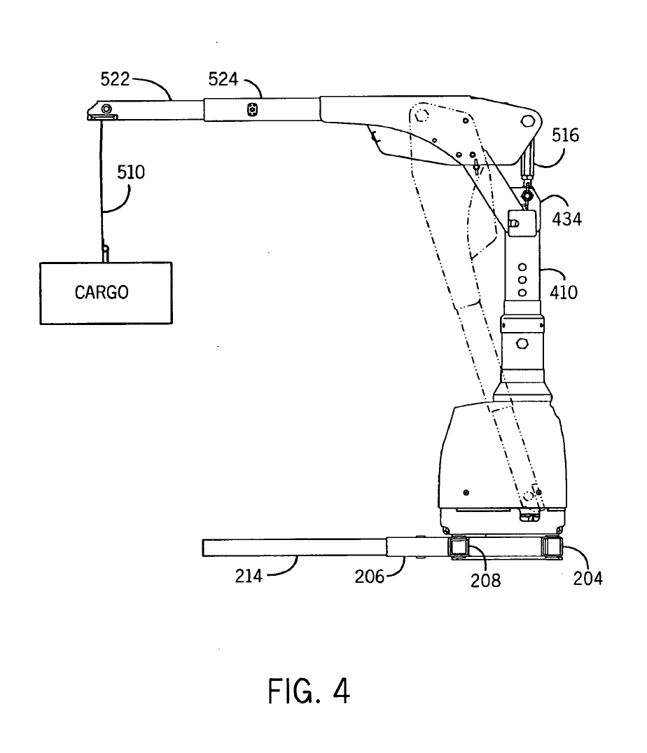

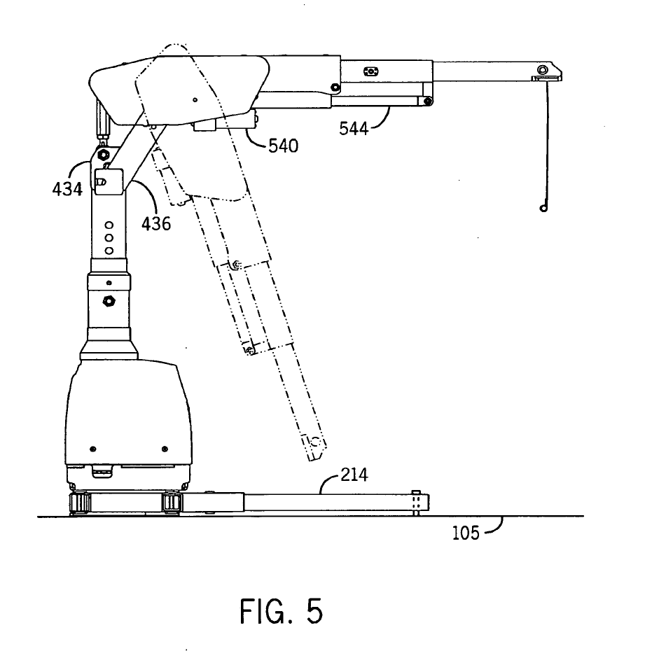

The boom angle can be pivotally adjusted by means of a turnbuckle 516, displaced opposite the lifting end of the boom to maximize the under-boom clearance when elevating the mobility device or other cargo. One end of the turnbuckle 516 is attached to the bracket 434 of mast offset arm mount 430 and the other end to the boom assembly 500. When the hoist 100 is not under load, the boom can be folded vertically by removing a hitch pin and pivoting it to a closed position, as shown in FIGS. 4 and 5. This creates additional cargo space access and improved rear vision in some vehicles.

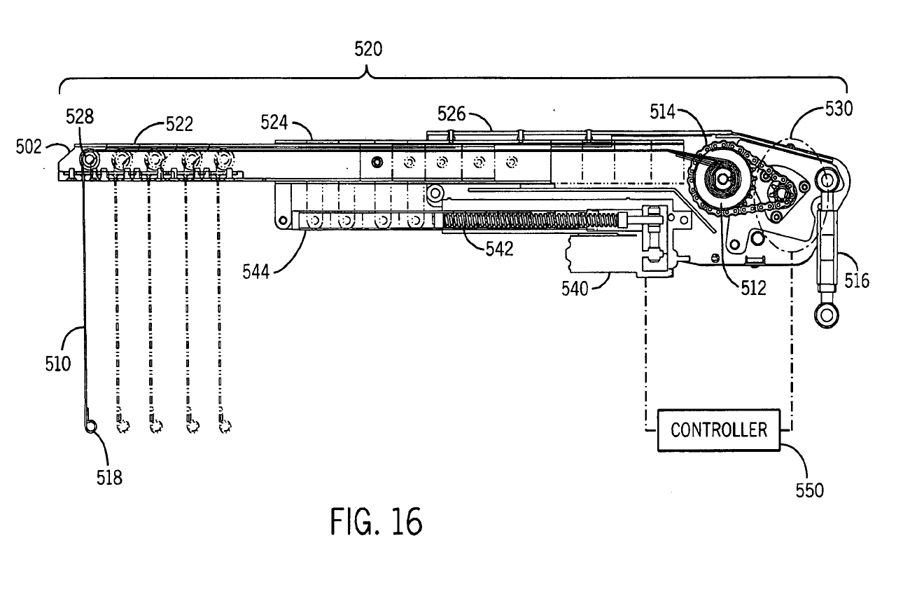

In some embodiments of the present invention, the head assembly 500 uses two motors or equivalents thereto—a belt drive motor and a boom extension motor, as described in more detail below. Head assembly 500 is mounted to mast 400 using the head mounting bracket 430 (discussed above with regard to mast assembly 400) and is used to control raising and lowering of cargo. As seen in FIG. 16, a boom 520 according to one embodiment of the present invention includes 3 telescoping segments—inner segment 522, middle segment 524 and outer segment 526 (the terms “inner” and “outer” refer to the relative diameters of the telescoping segments). A belt 510 is fed through the boom 520 using a roller 528 adjacent the outer end terminus 502 of boom segment 522. Belt 510 is accumulated on a winding drum or spool 512 or the like in head assembly 500. In some embodiments, belt 510 can be stored in an apparatus at the outer end terminus 502 of the boom so that belt 510 is not enclosed by the boom at all.

As shown in the Figures, a chain drive speed reduction 514 can be used to transmit motion from the output shaft of belt drive motor unit 530 to control rotation of the spool 512 to play out and reel in belt 510. An appropriate latching, hook or lifting link 518 (also referred to herein as a cargo attachment point) can be attached to the end of belt 510 to engage the docking means on the mobility device or otherwise assist in lifting cargo (for example, a scooter, wheelchair or other personal mobility vehicle).

Further hoist movement is provided with an optional boom extension drive in the lift head assembly. This boom extension drive consists of a linear actuator unit extending and retracting the boom length when cargo needs to be placed farther outside the vehicle (for example, to clear the motor vehicle bumper or other external structure), or to accommodate motor vehicle hatch geometry. This boom extension drive system is located at a fixed position at the inboard end of the boom.

In some embodiments of the present invention, the cargo attachment point vertical position can be maintained at a constant height while the boom is being extended and retracted (that is, while the length of the boom is increased and decreased). A controller coordinates the boom extension drive and the belt drive, thus providing desired belt length compensation. By placing the bulky belt drive system in proximity to the mast in some embodiments, more vertical hoist travel is available to lift large mobility devices in a limited vertical space. Also, this position counterbalances the boom while being folded vertically.

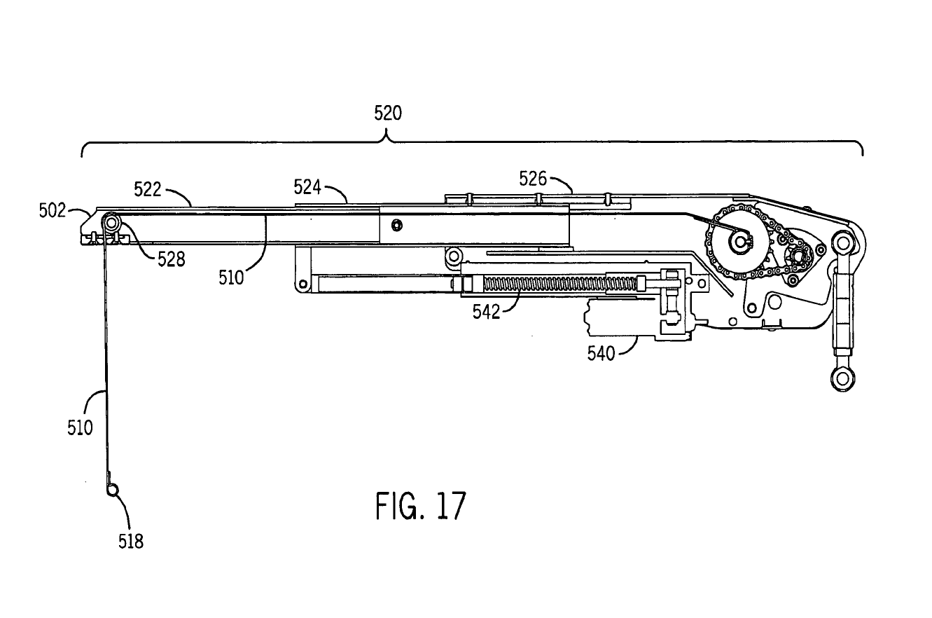

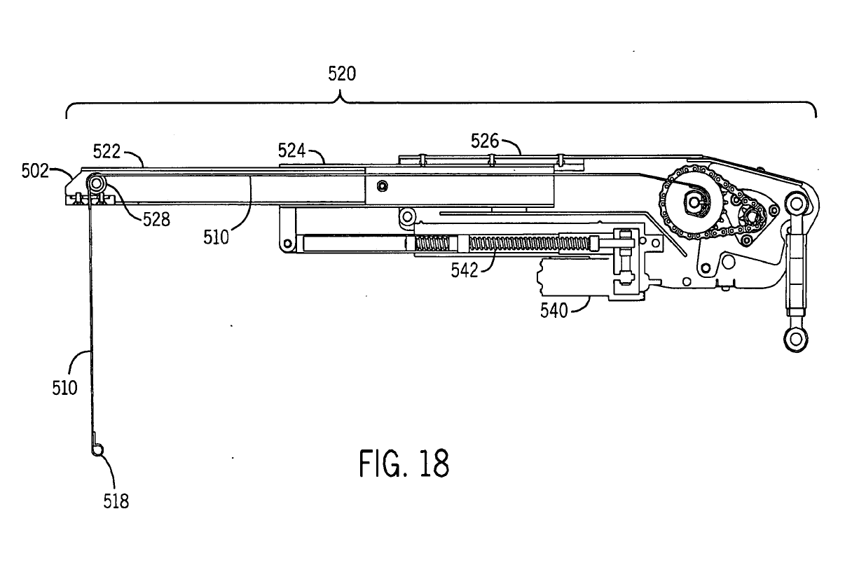

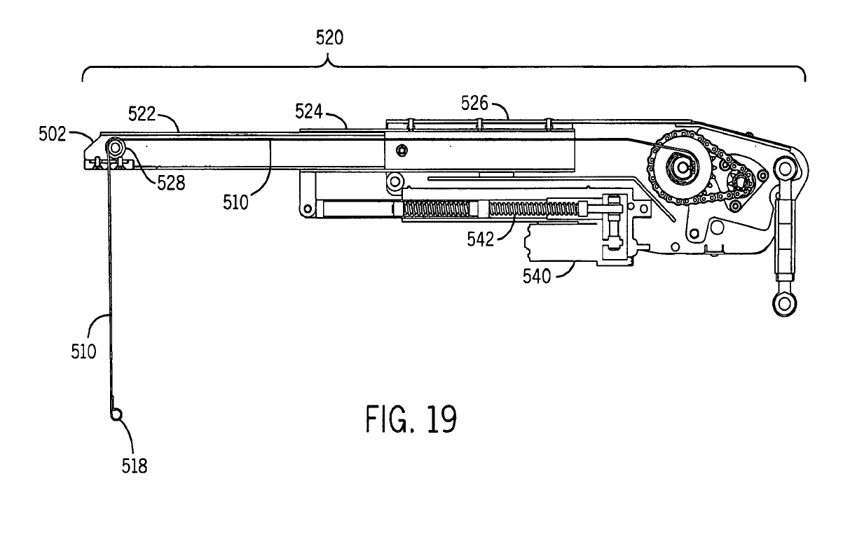

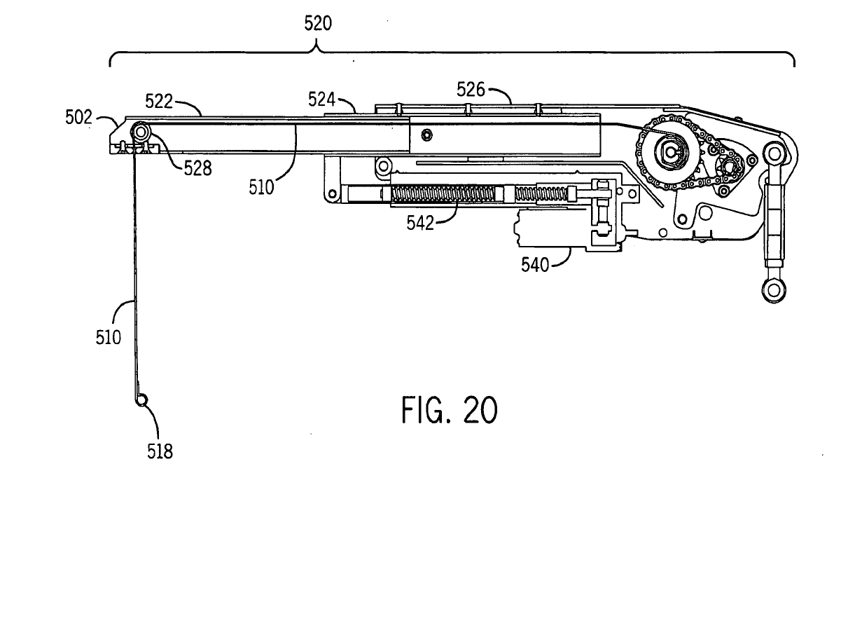

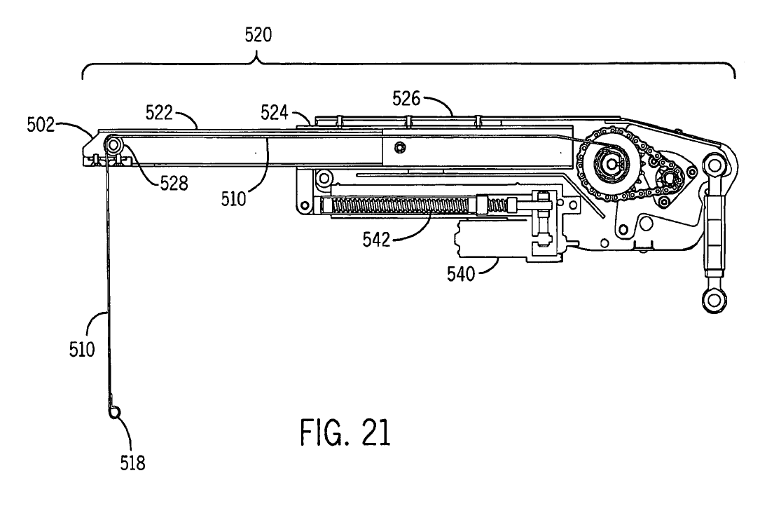

Thus, some embodiments of the present invention include a system for extending and retracting the boom outer end terminus 502, as seen in the multi-positional diagram of FIG. 16. The boom extension drive uses a boom extension motor unit 540 to control extension and retraction of the middle boom segment 524 (inner segment 522 and middle segment 524 maintain a constant position relative to one another (though their position relative to one another can be adjusted at installation, maintenance, refitting into a new motor vehicle, etc. using a set screw or the like, as seen in the Figures); the middle segment 524 moves only relative to outer segment 526 in the illustrated embodiment of invention). In the embodiment of the present invention shown in FIGS. 16-21, boom extension motor 540 turns a screw actuator 542 over which a sleeve 544 traverses. The outer end of sleeve 544 is mounted to middle segment 524 of boom 520. Full extension of boom segment 524 is shown in FIG. 17, with varying degrees of retraction shown in FIGS. 18-21.

FIG. 4 shows an embodiment of the present invention in which no power boom length adjustment is available, the boom length being set and/or adjusted by a dealer or other installation individual. FIG. 5, on the other hand, shows an embodiment of the present invention using a linear actuator to provide power adjustment of the boom length (which makes belt compensation possible, though not required). In both embodiments shown in FIGS. 4 and 5, the lift can be folded to some degree to further reduce storage size of the lift in a motor vehicle storage space. In both FIGS. 4 and 5, the head assembly of the lift is foldable about the offset pivot 436 of the head mounting mechanism 430. Folding can be achieved in various ways, including releasing at least one end of the turnbuckle 516. As seen in FIGS. 3 and 4, a fold down pin can be used to secure the lift in its folded position. Other means for folding and locking the lift in its folded position will be apparent to those skilled in the art.

Using embodiments of the present invention, motor units 530, 540 can coordinate their operation so that sufficient, but not excessive, slack is available in the belt 510 at the outer end terminus 502 of boom 520. This typically involves maintaining the belt's cargo attachment point 518 at a constant height. A controller 550 can include a microprocessor or the like that coordinates operation of the motors in units 530 and 540. In one system, controller 550 uses a closed loop system that actually measures the rotation of the shafts of motors in units 530 and 540, takes into account any gear reductions or other adjustments, and then proportionally plays out or reels in the belt 510 using spool 512 so that a generally constant amount of slack of belt 510 is available outside of roller 528. In an open loop system, controller 550 can measure the EMF, current or other electrical signals used in connection with the belt and boom extension motors in 530 and 540. With these measured values, the controller 550 can use a lookup table or other reference to determine how much operation of the belt motor is needed to maintain a generally constant slack of belt outside of roller 528.

As noted above, the belt compensation system more particularly can use a combination of motors to assist a person in moving a scooter, wheelchair or similar device into and out of a vehicle. To keep the lifted device at a particular height while adjusting the boom length (that is, when extending or retracting the lift head's boom outer end terminus 502), the amount of belt extending through the boom can be adjusted automatically. In some embodiments of the present invention, the boom extension motor unit 540 is a linear actuator that includes encoding capability. One example of such a device is the LAS3-1 model linear actuator made by Hiwin Mikrosystem Corporation. This type of device can provide a signal to the controller 550 (for example, a microprocessor, microcontroller, etc.) that collects and adds/subtracts pulses sent from the motor unit 540 to determine the relative position of the linear actuator and thus the position/length of the boom 520.

Controller 550 then controls the belt motor unit 530, which can include encoding capability as well (for example, an encoder integral to or coupled to the belt motor itself). The belt motor unit 530 can include an optical shaft encoder coupled directly to the motor output shaft (which turns the belt winding spool 512). One example of an appropriate optical shaft encoder is the S5 model made by US Digital of Vancouver, Wash. The optical shaft encoder can also provide positional data to the controller 550 (for example, pulses indicating the position of the belt winding drum 512). The controller 550 can then reconcile positional differences as desired, again taking into account the amount of belt on spool 512, the thickness of the belt, etc. It may also be possible for an encoder or the like to actually measure the length of belt that has been extended by optically “viewing” belt movement itself.

Since the boom extension motor typically runs at a relatively slow speed, the controller 550 can adjust the speed of the belt motor by comparing pulse frequencies from encoders. The speed ratio is known and used to compensate for minor speed variations. The speed of the belt motor may be adjusted only during extension and retraction of the boom length. If the belt motor is run alone (or in other situations where coordination as that sometimes needed with the boom extension motor), then it can be run at full speed. When the belt compensation apparatus is used, the belt motor will feed out the belt when the boom extension motor is extending the boom 520. Conversely, the belt motor will roll up belt during boom retraction.

Thus the improved, modular lifting device shown in connection with embodiments of the present invention provides more universality for applications. A dealer, for example, can order a standard lift model and, using its multi-configurational positioning apparatus, configure the lift to a particular vehicle, mobility device and vehicle mounting position/location (for example, passenger or driver side) without requiring a custom mounting base or other custom components or equipment. A single model of lift also can be transferred from one motor vehicle to another motor vehicle more readily. “Warehouse models” can be provided to improve delivery time. Installation is simplified with the improved mounting base design and reversible head assembly mount. Field service is simpler with embodiments of the modular hoist of the present invention, facilitating substitution of standardized components for several models.

The many features and advantages of the present invention are apparent from the written description, and thus, the appended claims are intended to cover all such features and advantages of the invention. Further, since numerous modifications and changes will readily occur to those skilled in the art, the present invention is not limited to the exact construction and operation as illustrated and described. Therefore, the described embodiments should be taken as illustrative and not restrictive, and the invention should not be limited to the details given herein but should be defined by the following claims and their full scope of equivalents, whether foreseeable or unforeseeable now or in the future.

1. A lift for loading and unloading a personal mobility vehicle into and out of a motor vehicle, the lift comprising a base assembly configured to be mounted to a motor vehicle storage space support surface; a mast assembly coupled to the base assembly, wherein the mast assembly comprises a generally vertical upright comprising a generally vertical post having an upper end and a bottom end coupled to the base assembly; and a head assembly coupled to the mast assembly, wherein the head assembly comprises a generally horizontal boom having an outer end outer end terminus and a belt for raising and lowering cargo secured to a cargo attachment point on the belt; characterized in that the lift further comprises a multi-configuration positioning apparatus, a direct drive apparatus and a belt compensation apparatus, wherein:
the multi-configuration positioning apparatus comprises:
a reversible head mount coupled to the vertical post upper end; and
a multi-positional base unit as part of the base assembly, wherein the multi-positional base unit comprises:
a reversible mounting plate assembly;
a first leg fixed to the mounting plate assembly;
a second leg fixed to the mounting plate assembly at a mounting angle relative to the first leg, the mounting angle being suitable for mounting the base assembly to the vehicle support surface; and
a third leg fixed to the mounting plate assembly and generally parallel to the second leg;
wherein the first leg, the second leg and the third leg are generally coplanar; and
further wherein the mast assembly comprises the direct drive assembly, the direct drive assembly comprising a mast motor coupled to the vertical post; and
further wherein the belt position compensation apparatus comprises:
a belt motor unit coupled to the belt for controlling reeling the belt in and out of the boom;
a boom extension motor unit coupled to the boom for increasing and decreasing the length of the boom by extending and retracting the outer end terminus of the boom; and
a controller coupled to the belt motor unit and to the boom extension motor unit for coordinating operation of the belt motor unit and the boom extension motor unit so that the cargo attachment point is maintained at a constant vertical height during extension and retraction of the outer end terminus of the boom.

2. The lift of claim 1 characterized in that the mast assembly further comprises a generally horizontal offset arm having a first end coupled to the upper end of the post and having a second end coupled to the head assembly.

3. The lift of claim 1 characterized in that the upright comprises a mast rotation tube coupled for rotation by the mast motor, wherein the mast rotation tube holds the post so that the post rotates with the mast rotation tube when the mast motor rotates the mast rotation tube.

4. The lift of claim 1 wherein the belt is at least partially enclosed by the boom.

5. The lift of claim 1 wherein the boom extension motor unit comprises a boom position encoder configured to generate a signal representing the position of the outer end terminus of the boom;
further wherein the belt motor unit comprises a belt position encoder configured to generate a signal representing the position of the belt; and
further wherein the controller compares the boom position encoder signal and the belt position encoder in coordinating the operation of the boom extension motor and the belt motor.

6. The lift of claim 1 wherein the head assembly is foldable.

7. The lift of claim 1 wherein the relative horizontal orientation of the boom is angularly adjustable using a turnbuckle coupled to the boom and to the mast assembly.

8. The lift of claim 1 wherein at least two of the legs of the base assembly are adjustable as to length.

9. The lift of claim 1 wherein the mast assembly is adjustable as to height.

10-22. (canceled)

23. A lift for loading and unloading a personal mobility vehicle into and from a motor vehicle, the lift comprising:
a base assembly configured for mounting to a support surface in a storage space in the vehicle;
a mast assembly coupled to the base assembly;
wherein the mast assembly comprises:
a generally vertical post; and
a direct drive assembly comprising a mast motor controlling rotation of the vertical post;
a head assembly coupled to the mast assembly.

24. The lift of claim 23 further comprising a mast rotation tube directly coupled to the mast motor, wherein the vertical post is held within and rotated by the mast rotation tube and further wherein the mast rotation tube comprises a plurality of limit switches for controlling limits of rotation of the mast rotation tube.

25. The lift of claim 23 wherein the base assembly is a multi-configurational base assembly comprising a reversible mounting plate assembly.

26. The lift of claim 23 wherein the head assembly is coupled to the mast assembly using a reversible head mount affixed to a horizontal offset arm having a first end coupled to the vertical post and having a second end coupled to the head assembly.

27. The lift of claim 23 wherein the head assembly comprises a generally horizontal telescoping boom assembly having an outer end boom terminus and a lifting belt coupled to the boom assembly, wherein the belt is played out to lower cargo secured to a cargo attachment point on the belt and is reeled in to raise cargo attached to the cargo attachment point.

28. The lift of claim 27 further comprising a belt motor coupled to the belt and configured to play out and reel in the belt;
further comprising a boom extension motor coupled to the boom assembly and configured to extend and retract the boom assembly; and
a controller coupled to the belt motor and to the boom extension motor, wherein the controller coordinates belt positioning so that the cargo attachment point is maintained at a constant vertical height by compensating for extension or retraction of the outer end boom terminus.

29. The lift of claim 28 wherein the controller uses at least one of the following: encoder signals representing the outer end boom terminus position, encoder signals representing the belt position, a closed loop control system or an open loop control system.

30-40. (canceled)
